(19) United States
(12) Patent Application Publication
(10) Pub. No.: US 2010/0234520 A1
(43) Pub. Date: Sep. 16, 2010

(54) Curable Epoxy Resin Composition and Cured Body Thereof

(76) Inventors: Yoshitsugu Morita, Chiba (JP); Hiroshi Ueki, Chiba (JP)

Correspondence Address: HOWARD & HOWARD ATTORNEYS PLLC, 450 West Fourth Street, Royal Oak, MI, 48067, US

(21) Appl. No.: 12/600,142

(22) PCT Filed: Apr. 25, 2008
(86) PCT No.: PCT/JP2008/058506

§ 371 Date: Nov. 13, 2009

(30) Foreign Application Priority Data
May 16, 2007 (JP) JP2007-130547

(51) Int. Cl. C08L 63/00

(52) U.S. Cl. 524/540; 525/523

(57) ABSTRACT

A curable epoxy resin composition comprising: (I) an epoxy resin; (II) a curing agent for the epoxy-resin; (III) cross linked silicone particles characterized by having secondary amino groups represented by the following general formula: R¹NH—R²— (where R designates an aryl group or an aralkyl group, and R designates a bivalent organic group) and bonded to silicon atoms that form the cross-linked silicone particles {the aforementioned cross-linked silicon particles being used in the amount of 0.1 to 100 parts by weight per 100 parts by weight of the sum of components (I) and (II)}, has excellent flowability in molding and can produce a cured body having low modulus of elasticity.

### TECHNICAL FIELD

The present invention relates to a curable epoxy resin composition and to a cured body obtained by curing the composition.

### BACKGROUND ART

Curable epoxy resin compositions find application as sealing, adhesive, and other agents used in the manufacture of electrical and electronic devices. However, the use of these agents is associated with problems, such as high modulus of elasticity and hence high rigidity of cured bodies obtained from these compositions that develops stress in parts of electrical and electronic devices during expansion and contraction when the aforementioned agents are used in such devices. Attempts have been made to reduce modulus of elasticity in cured bodies obtained from the aforementioned curable epoxy resin compositions by combining the compositions with cross-linked silicon particles having triaminopropyl groups or similar primary amino groups, or N-(2-aminoethyl)-3-aminopropyl, or similar secondary amino groups (see Japanese Unexamined Patent Application Publications S58-219218 and H04-266928).

The above cross-linked silicone particles did not have sufficient dispersibility in the curable epoxy resin compositions and had poor affinity for the composition. Furthermore, decrease in modulus of elasticity of a cured body was still insufficient, and, because of high reactivity of the particles, the curable epoxy resin composition showed a tendency to gel during preparation or storage, and this, in turn, reduced flowability of the composition during molding.

It is an object of the present invention to provide a curable epoxy resin composition that is characterized by excellent flowability during molding, low modulus of elasticity of a body obtained from this composition, and suitability for use as a sealing or adhesive agent in the manufacture of semiconductor devices.

It is another object to provide a cured body having a low modulus of elasticity.

### DISCLOSURE OF INVENTION

The above problems are solved by means of the present invention that provides a curable epoxy resin composition comprising the following components (I), (II), and (III):

(I) an epoxy resin;

(II) a curing agent for the epoxy-resin;

(III) cross-linked silicone particles characterized by having secondary amino groups represented by the following general formula:

R¹NH—R²—

(where R¹ designates an aryl group or an aralkyl group, and R² designates a bivalent organic group) and bonded to silicon atoms that form the cross-linked silicone particles {the aforementioned cross-linked silicone particles being used in an amount of 0.1 to 100 parts by weight per 100 parts by weight of the sum of components (I) and (II)}.

### Effects of Invention

The curable epoxy resin composition of the invention is characterized by excellent flowability during molding and, when cured, forms a cured body having a low modulus of elasticity.

### DETAILED DESCRIPTION OF THE INVENTION

An epoxy resin of component (I) is a main component of the composition of the invention. There are no special restrictions with respect to this resin provided that the resin contains one or more glycidyl groups, alicyclic epoxy groups, or similar epoxy groups. Most preferable are compounds having two or more epoxy groups. Component (I) may comprise a silicone resin or an organic resin with an epoxy group. The use of an organic resin is preferable. Examples of an organic resin with an epoxy group are the following: novolac-type epoxy resin, cresol-novolac type epoxy resin, triphenol-alkane type epoxy resin, aralkyl-type epoxy resin, aralkyl-type epoxy resin having a biphenyl skeleton, biphenyl-type epoxy resin, dicyclopentadiene-type epoxy resin, heterocyclic epoxy resin, epoxy resin containing a naphthalene ring, bisphenol-A type epoxy resin, bisphenol-F type epoxy resin, stilbene-type epoxy resin, trimethylol-propane type epoxy resin, terpene-modified epoxy resin, a linear aliphatic epoxy resin obtained by subjecting olefin bonds to oxidation with acetic peracid, or a similar peracid, alicyclic epoxy resin, or sulfur-containing epoxy resin. Component (I) may comprise a combination of two or more of such resins. Most preferable for use as component (I) are the aralkyl-type epoxy resin that contains a biphenyl skeleton, the biphenyl-type epoxy resin, or a similar biphenyl-containing epoxy resin.

Normally, component (I) is readily available. Thus, the biphenyl-type epoxy resin is commercially produced by Japan Epoxy Resin Co., Ltd. under the trademark YX-4000. The bisphenol-F type epoxy resin can be acquired as a product known under the trademark VSLV-80XY manufactured by Shinnitetsu Kagaku Co., Ltd.; the aralkyl-type epoxy resin having a biphenyl skeleton can be obtained as products NC-3000 and CER-3000L (a mixture of biphenyl-epoxy resins) from Nippon Kayaku Co., Ltd.; and the naphthol-aralkyl type resin can be obtained as ESN-175 from Shinnitetsu Kagaku Co., Ltd.

When the composition of the invention is used as a sealing or adhesive agent for semiconductor devices, it is recommended that component (I) contain hydrolyzable chlorine in an amount not exceeding 1000 ppm, preferably not exceeding 500 ppm per weight of component (I). Furthermore, the content of sodium or potassium in component (I) should not exceed 10 ppm per weight of component (I). If the content of hydrolyzable chlorine, or the content of sodium and potassium, exceeds the recommended upper limit, this will impair moisture-resistant properties of the sealing or adhesive agent if such an agent is used under conditions of high temperature and high humidity.

Component (II) is a curing agent used for reacting with epoxy groups of component (I) and for curing the composition. Component (II) may comprise a compound that contains phenolic hydroxyl groups and may be exemplified by phenol novolac-type resin, phenolic resin that contains a naphthalene ring, aralkyl-type phenolic resin, triphenolalkane-type phenolic resin, phenolic resin that contains biphenyl groups, alicyclic phenolic resin, heterocyclic phenolic resin, phenolic resin that contains a naphthalene ring, bisphenol A, or bisphenol F. A combination of two or more compounds that contain phenolic hydroxyl groups can be used as component (II). Most preferable are aralkyl-type phenolic resins that contain biphenyl groups, or similar biphenyl-containing phenolic resins.

Component (II) is readily available. For example, the aralkyl-type phenolic resin can be obtained from Mitsui Chemical Company as a product known under the trademark XLC-3L or from Meiwa Kasei Co., Ltd. as a product known under the trademark MEH-781; the phenolic resin that contains a naphthalene ring can be obtained from Shinnitetsu Kagaku Co., Ltd. as products known under the trademark SN-475 and SN-170; the phenol novolac resin can be obtained from Meiwa Kasei Co., Ltd. as a product under the trademark MEH7500; and the biphenyl-containing phenolic resin can be obtained from Meiwa Kasei Co., Ltd. as a product under the trademark MEH7851M.

There are no special restrictions with regard to the amount in which component (II) can be added to the composition provided that this amount is sufficient for curing component (I). It may be recommended, however, to add component (II) in such an amount that the content of the epoxy-reactive functional groups in component (II) be in the range of 0.5 to 2.5 moles per 1 mole of epoxy groups contained in component (I). For example, when component (II) is a compound that contains phenolic hydroxyl groups, the content of the phenolic hydroxyl groups in component (II) may be in the range of 0.5 to 2.5 moles per 1 mole of epoxy groups in component (I). If component (II) is used in an amount less than the recommended lower limit, the will result in insufficient curing of the composition and, if, on the other hand, the content of component (II) exceeds the recommended upper limit, this will reduce strength of a cured body obtained from the composition.

Component (III) is used for preventing decrease of flowability during molding and for reducing the modulus of elasticity in a cured body obtained from the composition of the invention. Component (III) comprises cross-linked silicone particles characterized by having secondary amino groups represented by the following general formula:

R¹NH—R²—

and bonded to silicon atoms that form the cross-linked silicone particles. In the above formula, R¹ designates aryl groups or aralkyl groups. The aryl groups designated by R¹ may be exemplified by phenyl, tolyl, xylyl, or naphthyl groups. The aralkyl groups designated by R¹ may be exemplified by benzyl, phenethyl, or phenylpropyl groups. Preferable are phenyl groups. Furthermore, R² in the above formula designates a bivalent organic group that can be represented by ethylene, methylethylene, propylene, butylenes, pentylene, hexylene, or a similar alkylene group; and ethyleneoxyethylene, ethyleneoxypropylene, ethyleneoxybutylene, propyleneoxypropylene, or a similar alkyleneoxyalkylene group. Most preferable are alkylene groups, especially ethylene and propylene groups.

There are no special restriction with regard to the form in which component (III) can be used. For example, this component can be used in the form of gel, rubber, or hard resin, of which rubber-like form is more preferable. A compound suitable for use as component (III) out of rubber-like compounds has diorganosiloxane blocks of the following general formula:

—(R³₂SiO)ₙ

where R³ designates same or different univalent hydrocarbon groups such as methyl, ethyl, propyl, butyl, pentyl, hexyl, octyl, decyl, octadecyl, or similar alkyl groups; cyclopentyl, cyclohexyl, cycloheptyl, or similar cycloalkyl groups; vinyl, allyl, propenyl, hexenyl, or similar alkenyl groups; phenyl, tolyl, xylyl, or similar aryl groups; benzyl, phenethyl, phenylpropyl, or similar aralkyl groups; 3-chloropropyl, 3,3,3-trifluoropropyl, or similar halogenated alkyl groups. Most preferable of these are methyl and phenyl groups, especially methyl groups. In the above formula, “n” is an integer equal to or greater than 3, preferably an integer in the range of 3 to 500, more preferably in the range of 5 to 500, and most preferably in the range of 5 to 100.

There are no special restrictions with regard to the shape of the particles of component (III), which may have a spherical, flat, or irregular shape. Spherical or substantially spherical particles are preferable since they provide excellent dispersibility in components (I) and (II) and improve flowability of the curable resin composition during molding. Also, there are no special restrictions with regard to an average size of the particles of component (III) but it may be recommended to have an average size in the range of 0.1 to 500 μm, preferably 0.1 to 200 μm, more preferably 0.1 to 100 μm, and most preferably 0.1 to 50 μm. This is because the particles having dimension smaller than the recommended lower limit cannot be easily produced, while the particles with dimensions exceeding the recommended upper limit have low dispersibility in components (I) and (II). The aforementioned average size of the particles can be represented by a median diameter (which is the particle diameter corresponding to 50% of the cumulative distribution) measured in an aqueous or ethanol dispersion of the particles with a Model LA-500 laser diffraction particle distribution measurement instrument of Horiba Seisakusho Co., Ltd.

There are no restrictions with regard to the amount in which the secondary amino groups can be contained in component (III), but preferably this amount should be in the range of 0.3 to 3.0 wt. %, more preferably 0.5 to 2.0 wt. %, and most preferably 0.5 to 1.8 wt. %. If component (III) contains secondary amino groups in an amount less than the recommended lower limit, this will impair either dispersibility of component (III) in component (I) and (II) or reactivity with respect to component (I). If, on the other hand, the content of the secondary amino groups in component (III) exceeds the recommended upper limit, this will diminish stability during preparation or storage. The content of secondary amino groups in component (III) can be determined by potential difference titration with use of a titrant in the form of a dioxane solution of perchloric acid and using component (III) in a mixture of chloroform with acetic acid.

There are no special restrictions with regard to hardness of component (III), but it may be recommended that hardness of component (III) in terms of type-A durometer units according to JIS K 6253 be in the range of 15 to 90, preferably 40 to 90, and most preferably 50 to 90. If hardness of the component (III) is below the recommended lower limit on the type-A durometer scale, this will either impair dispersibility of component (III) in components (I) and (II), or reduce flowability of the curable epoxy resin composition during molding. If, on the other hand, hardness of the particles exceeds the recommended upper limit, this will reduce modulus of elasticity in a cured body obtained by curing the aforementioned curable epoxy resin composition. Type A durometer hardness can be determined by curing the cross-linkable silicone composition intended for forming component (III) and prepared in a sheet-like form, and then measuring hardness of the sheet-like cured body after the composition has been cross-linked.

There are no special restriction with regard to a method for the preparing aforementioned component (III). For example, the manufacturing method of the present invention may consist of cross-linking in a water-dispersed state a cross-linkable silicone composition comprising the following components:

(A) an organopolysiloxane that contains in one molecule at least two silanol groups;

(B) an alkoxysilane that contains a secondary amino group and is represented by the following general formula:

R¹NH—R²—SiR⁴ₐ(OR⁵)₍₃₋ₐ₎

(where R¹ is an aryl group or an aralkyl group; R² is a bivalent organic group; R⁴ is a univalent hydrocarbon group; R⁵ is an alkyl group; and “a” is 0 or 1); and

(C) a condensation-reaction catalyst.

An organopolysiloxane of component (A) contains in one molecule at least two silanol groups. Silicon-bonded groups other than silanol groups contained in component

(A) may be represented by methyl, ethyl, propyl, butyl, pentyl, hexyl, octyl, decyl, octadecyl, or similar alkyl groups; cyclopentyl, cyclohexyl, cycloheptyl, or similar cycloalkyl groups; vinyl, allyl, propenyl, hexenyl, or similar alkenyl groups; phenyl, tolyl, xylyl, or similar aryl groups; benzyl, phenethyl, phenylpropyl, or similar aralkyl groups; 3-chloropropyl, 3,3,3-trifluoropropyl, or similar halogenated alkyl groups. Most preferable are methyl and phenyl groups. There are no restrictions with regard to the molecular structure of component (A), and this component may have a linear or a partially branched linear structure. Also, there are no special restrictions with regard to viscosity of component (A) provided that the aforementioned composition can be easily dispersed in water. It may be recommended, however, to maintain the viscosity of component (A) at 25° C. in the range of 20 to 100,000 mPa·s, preferably in the range of 20 to 10,000 mPa·s.

In order to provide component (A) in component (III) in the form of rubber with introduction of an organosiloxane block represented by the following general formula,

—(R³₂SiO)ₙ—,

it is preferable to use an organopolysiloxane of the following general formula:

HO—(R³₂SiO)ₙ—H

In this formula, R³ designates same or different univalent hydrocarbon groups, which may be exemplified by the groups mentioned above. In the above formulae, “n” is an integer equal to or greater than 3 and may be represented by the same integers as mentioned above.

An alkoxysilane of component (B) that contains a secondary amino group is represented by the following general formula:

R¹NH—R²—SiR⁴ₐ(OR⁵)₍₃₋ₐ₎

In this formula, R¹ designates an aryl group or an aralkyl group and may be exemplified by the groups mentioned above, of which the phenyl group is preferred; R² designates a bivalent organic group, which may be exemplified by the groups mentioned above and of which alkylene groups and especially ethylene and propylene groups are preferable; R⁴ designates a univalent hydrocarbon group that may be represented by methyl, ethyl, propyl, butyl, pentyl, hexyl, octyl, decyl, octadecyl, or a similar alkyl group; cyclopentyl, cyclohexyl, cycloheptyl, or a similar cycloalkyl group; vinyl, allyl, propenyl, hexenyl, or a similar alkenyl group; phenyl, tolyl, xylyl, or a similar aryl group; benzyl, phenethyl, phenylpropyl, or a similar aralkyl group; 3-chloropropyl, 3,3,3-trifluoropropyl, or a similar halogenated alkyl group. Most preferable of these are methyl and phenyl groups.

Furthermore, in the above formula, R⁵ represents an alkyl group such as methyl, ethyl, or propyl group. Most preferable of these is methyl group. In the above formula, “a” is 0 or 1.

There are no special restrictions with regard to the amount in which component (B) can be used provided that this amount is sufficient for cross-linking the composition. It may be recommended to add component (B) in the amount of 0.01 to 100 parts by weight, preferably 0.01 to 50 parts by weight, and most preferably 0.01 to 20 parts by weight per 100 parts by weight of component (A). If component (B) is used in an amount less than the recommended lower limit, this will impair dispersibility of component (III) in components (I) and (II) and if, on the other hand, the added amount exceeds the recommended upper limit, this will impair cross-linking of the obtained silicone composition.

A condensation-reaction catalyst that constitutes component (C) is used to accelerate the condensation reaction of the aforementioned composition and may be represented by dibutyltin dilaurate, dibutyltin diacetate, tin octanoate, dibutyltin dioctate, tin laurate, or a similar organic tin compound; tetrabutyltitanate, tetrapropyltitanate, dibutoxybis(ethylacetoacetate)titanium, or a similar organic titanium compound; hydrochloric acid, sulfuric acid, dodecylbenzenesulfonic acid, or a similar acidic compound; and ammonia, sodium hydroxide, or a similar alkali compound. Of these, most preferable are organic tin compounds and organic titanium compounds.

There are no special restrictions with regard to the amount in which component (C) can be used provided that the amount accelerates the condensation reaction of the aforementioned compound. It may be recommended to add component (C) in the amount of 0.01 to 10 parts by weight, preferably 0.05 to 5 parts by weight per 100 parts by weight of component (A). If component (C) is added in an amount less than the recommended lower limit, this will impair cross-linking of the obtained silicone composition and if, on the other hand, the added amount exceeds the recommended upper limit, cross-linking of the obtained cross-linkable silicone composition will be over-accelerated to the extent that preparation of cross-linked silicone particles will be difficult.

If necessary, the aforementioned composition can be combined with arbitrary components such as an organopolysiloxane (D) that contains in one molecule at least two silicon-bonded hydrogen atoms. Silicon-bonded groups other than hydrogen atoms contained in component (D) may be represented by methyl, ethyl, propyl, butyl, pentyl, hexyl, octyl, decyl, octadecyl, or similar alkyl groups; cyclopentyl, cyclohexyl, cycloheptyl, or similar cycloalkyl groups; phenyl, tolyl, xylyl, or similar aryl groups; benzyl, phenethyl, phenylpropyl, or similar aralkyl groups; 3-chloropropyl, 3,3,3-trifluoropropyl, or similar halogenated alkyl groups, or other univalent hydrocarbon groups that are free of aliphatic unsaturated bonds. Of these, most preferable are methyl and phenyl groups. There are no special restrictions with regard to the molecular structure of component (D), and this component may have a linear, branched, partially branched linear, or cyclic structure, preferable of which is a linear structure. Also, there are no restrictions with regard to viscosity of component (D). However, it may be recommended that the viscosity at 25° C. be in the range of 1 to 100,000 mPa·s, preferably in the range of 1 to 10,000 mPa·s.

Component (D) can be used in an arbitrary amount; however from the viewpoint of accelerating the cross-linking of the composition by adding component (D), it is preferable that component (D) be added in an amount less than 100 parts by weight, preferably 0.1 to 100 parts by weight, more preferably 0.1 to 50 parts by weight, and most preferably 0.1 to 30 parts by weight per 100 parts by weight of component (A). If component (D) is added in an amount less than the recommended lower limit, then it will be difficult to accelerate cross-linking of the obtained cross-linkable silicone composition. If, on the other hand, the added amount exceeds the upper recommended limit, then it will be difficult to cross-link the obtained silicone composition.

In order to improve mechanical strength of the obtained cross-linked silicone particles and to increase hardness of the particles, the composition can be additionally combined with ethylsilicate, tetraethoxysilane, methylsilicate, tetramethoxysilane, or similar compounds that can be added in amounts not contradictory to the objects of the present invention.

For further improvement of physical properties of component (III), the composition may be combined with an inorganic filler, which may be represented by silicon oxide, titanium oxide, aluminum oxide, zirconium oxide, antimony oxide, or a similar finely powdered metal oxide; boron nitride, aluminum nitride, or a similar finely powdered metal nitride; aluminum hydroxide, magnesium hydroxide, or a similar finely powdered metal hydroxide; calcium carbonate or a similar metal carbonate; nickel, cobalt, iron, copper, gold, silver, or a similar fine metal powder; as well as finely powdered sulfide compounds and chloride compounds. From the viewpoint of availability, it is preferable to use finely powdered metal oxides, particularly finely powdered silica. Surface of the aforementioned inorganic fillers can be subjected to hydrophobization with organic silicon compounds such as organoalkoxysilane, organochlorosilane, organosilazane, or the like.

The manufacturing method of the cross-linked silicone particles of component (III) consists of preparing a cross-linkable silicone composition comprising components (A), (B), and (C) and then cross-linking the composition in a water-dispersed state, or by preparing the silicone composition comprising components (A) and (B) and dispersing the obtained composition in water and cross-linking the composition after addition of component (C). In the latter case, component (C) can be added in the form of an aqueous dispersion prepared by dispersing particles of an average size not exceeding 10 μm in water.

A process that can be used in the manufacturing method for adjusting the size of the cross-linked silicone particles consists of adjusting viscosity of the cross-linkable silicone composition, by selecting a type of surfactant used for dispersing the cross-linkable silicone composition in water, or by adjusting stirring speed. Furthermore, after dispersing the silicone composition comprised of components (A) and (B) in a dispersing medium such as water, the size of the cross-linked silicone particles can be easily adjusted by adding component (C) and cross-linking the mixture. Another process consists of sorting the cross-linking silicone particles by passing them through a sieve.

The aforementioned surfactant may be exemplified by nonionic, anionic, cationic, or betainic surfactants. The size of particles in the obtained component (III) can be adjusted by selecting the amount and type of the aforementioned surfactants. In order to adjust the particles of component III to a smaller size, it is recommended to add the surfactant in an amount of 0.5 to 50 parts by weight per 100 parts by weight of the cross-linkable silicone composition. On the other hand, in order to increase the size of the particles, it is recommended to add the surfactant in an amount of 0.1 to 10 parts by weight per 100 parts by weight of the cross-linkable silicone composition. In case of using water as a dispersing medium, water can be used in an amount of 20 to 1500 parts by weight per 100 parts by weight of the cross-linkable silicone composition.

It is recommended to uniformly disperse the cross-linkable silicone composition in a dispersing medium by using an emulsifier such as a homogenous mixer, paddle mixer, Henschel mixer, homogenous disperser, colloidal mill, propeller-type agitator, homogenizer, in-line-type continuous emulsifier, ultrasonic emulsifier, vacuum-type continuous mixer, etc. A dispersion, or slurry, of the cross-linkable silicone composition thus obtained can be cross-linked by adding the required condensation-reaction catalyst, whereby a dispersion, or slurry, of component (III) is obtained. Final component (III) is obtained after removing the dispersing medium from the dispersion, or slurry.

In the method, if the dispersing medium is water, the latter can be removed, e.g., by thermal dehydration, filtration, centrifugal separation, decantation, etc., and after the dispersion is condensed, the product can be washed with water if necessary. The product can be further dried by the following methods: heating at normal or reduced pressure, pulverizing the dispersion in a flow of hot air, or heating by using a flow of a hot medium. If component (III) obtained after removal of the dispersing medium aggregate, they may further disintegrated in a jet mill or mortar.

In the composition of the invention, component (III) should be contained in the amount of 0.1 to 100 parts by weight, preferably 0.1 to 50 parts by weight, and most preferably 0.1 to 20 parts by weight, per 100 parts by weight of the sum of components (I) and (II). If component (III) is added in an amount less than the recommended lower limit, this will show a tendency to increase of modulus of elasticity in a cured body obtained from the composition. If, on the other hand, the added amount exceeds the recommended upper limit, this will reduce strength of the cured body.

For increasing the strength of a cured body, the composition may contain a fourth component (IV) in the form of an inorganic filler. The strength of a cured body can be increased by using inorganic fillers conventionally added to curable epoxy resin compositions, but the use of such fillers with conventional compositions impairs flowability and moldability of the aforementioned compositions. Moreover, such fillers noticeably increase modulus of elasticity of cured bodies obtained from the aforementioned compositions. However, since in the composition of the invention component (IV) is used together with component (III), flowability and moldability is not impaired, and, in spite of having a low modulus of elasticity, cured bodies obtained from the composition have extremely high strength.

There are no special restrictions with regard to component (IV) provided that this component is an inorganic filler that normally can be combined with a curable epoxy resin composition. For example, this can be glass fiber, asbestos, alumina fiber, ceramic fiber having alumina and silica as components, boron fiber, zirconia fiber, silicon carbide fiber, metal fiber, or a similar fibrous filler; amorphous silica, crystalline silica, precipitated silica, fumed silica, baked silica, zinc oxide, baked clay, carbon black, glass beads, alumina, talc, calcium carbonate, clay, aluminum hydroxide, magnesium hydroxide, barium sulfate, titanium dioxide, aluminum nitride, boron nitride, silicon carbide, aluminum oxide, magnesium oxide, titanium oxide, beryllium oxide, kaolin, mica, zirconia, or similar powdered fillers. Component (IV) may comprise a combination of two or more of the aforementioned compounds. Also there are no special restrictions with regard to the shape of component (IV) particles, which may have spherical, needle-like, flat, or irregularly crushed shape. The spherical shape is preferable from the viewpoint of better conditions for moldability. Most preferable for component (IV) is a spherical amorphous silica. There are no special restrictions with regard to the size of the particles of component (IV) but for better conditions of moldability it is recommended to have the particle size in the range of 0.1 to 50 A combination of two or more inorganic fillers having particles of different average sizes can be used as well.

In order to improve affinity for component (I), component (IV) can be surface-treated with a silane-coupling agent, titanate coupling agent, or a similar coupling agent. The silane coupling agent can be exemplified by 3-glycidoxypropyl trimethoxysilane, 3-glycidoxypropyl methyldiethoxysilane, 2-(3,4-epoxycyclohexyl)ethyltrimethoxysilane, or similar epoxy-containing alkoxysilanes; N-(2-aminoethyl)-3-aminopropyl trimethoxysilane, 3-aminopropyl triethoxysilane, N-phenyl-3-aminopropyl trimethoxysilane, or a similar amino-containing alkoxysilane; 3-mercaptopropyl trimethoxysilane, or similar mercapto-containing alkoxysilanes; as well as 3-isocyanatepropyl trimethoxysilane, and 3-ureidopropyl trimethoxysilane. The titanate coupling agent can be exemplified by i-propoxytitane tri(i-isostearate). Two or more coupling agents of different types can be used in combination. There are no special restrictions with regard to the method of surface treatment and the amount in which the coupling agents can be used for surface coating.

In the composition of the invention, component (IV) should be used at least in the amount of 20 wt. %, preferably at least 30 wt. %, more preferably at least 50 wt. %, and most preferably 80 wt. %. If the content of component (IV) is less than the recommended lower limit, it will be impossible to provide sufficient increase of strength in a cured body of the composition.

In the composition of the invention, component (IV) can be dispersed in components (I) and (II). Furthermore, for improving affinity of component (IV) for component (I) or for components (II) and (III), a silane coupling, titanate coupling, or a similar coupling agent can be added.

The composition of the invention can be further combined with (V) a curing accelerator for the epoxy-resin. Specific examples of component (V) are the following: triphenylphosphine, tributylphosphine, tri(p-methylphenyl)phosphine, tri(nonylphenyl) phosphine, triphenylphospnine-triphenylborate, tetraphenylphosphine-tetraphenylborate, tetraphenylphosphine-quinone adduct, or similar phosphorous-type compounds; triethylamine, benzyldimethylamine, a-methylbenzyldimethylamine, 1,8-diazabicyclo [5.4.0] undecene-7, or similar tertiary-amine compounds; 2-methylimidazol, 2-phenylimidazol, 2-phenyl-4-methylimidazol, or similar imidazole compounds.

There are no special restrictions with regard to the amount in which component (V) can be added to the composition but it may be recommended to add this component in an amount of 0.001 to 20 parts by weight per 100 parts by weight of component (I). If the added amount is less than the recommended lower limit, it will be difficult to accelerate reaction of components (I) and (II). If, on the other hand, the added amount exceeds the recommended upper limit, this will impair strength of a cured body obtained from the composition.

If necessary, the composition can be combined with other additives such as thermoplastic resin, thermoplastic elastomer, organic synthetic resin, silicone, or a similar stress-reducing agent; carnauba wax, higher fatty acid, synthetic wax, or a similar wax; carbon black or a similar coloring agent; a halogen trapping agent, an ion capturing agent, etc.

There are no special restrictions with regard to the method of preparation of the composition of the invention. The composition can be prepared by uniformly mixing components (I) to (III), if necessary with other arbitrary components. It is possible to improve dispersity of component (III) if it is blended with premixed components (I) and (II). Alternatively, components (II), (III), and, if necessary, arbitrary components, can be added to premixed components (I) and (IV). In the latter case, components (I) and (IV) can be used in an integral blend with a coupling agent. Prior to mixing, component (IV) can be subjected to surface treatment with a coupling agent. Equipment suitable for preparation of the composition may comprise a single-shaft or double-shaft continuous mixer, two-roll mill, Ross® mixer, kneader-mixer, Henschel mixer, or the like.

### Examples

The curable epoxy-resin composition of the invention and a cured body obtained therefrom will be further explained with reference to practical and comparative examples. The characteristics used in these examples have values measured at 25° C.

Furthermore, the following methods were used for measuring the characteristics of cross-linked silicone particles.

### [Average Particle Size]

Average particle size was measured in an aqueous-dispersed state by means of a Model LA-500 laser-diffraction particle-distribution measurement instrument of Horiba Seisakusho Co., Ltd. as a median diameter (which is the particle diameter corresponding to 50% of the cumulative distribution). The obtained median diameter was considered to be the average size of a cross-linked silicone particle.

### [Type-A-Durometer Hardness]

The condensation-cross-linkable silicone composition used for forming the cross-linked silicone particles was deaerated, and after retaining for one day at a temperature of 25° C., the composition was formed into a 1-millimeter-thick cross-linked silicone sheet. Type-A-durometer hardness in accordance with JIS K 6253 was determined by measuring hardness of the sheet with use of the H5B microhardness tester for rubber, the product of H. W. Wallace Company.

### [Content of Amino Groups]

Cross-linked silicone particles measured in the precise weight of 0.2 g were placed into a beaker, mixed with 30 ml of chloroform and 10 ml of acetic acid, and then by using a titration solution in the form of a 0.01 N dioxane solution of perchloric acid (a factor of perchloric acid solution: F), the content of amino groups in the cross-linked silicone particles was determined from the end point, i.e., equivalent point (ml), with use of a potentiometric titration instrument by means of the following formula:

Content of amino groups (wt. %)={[0.01×F×(equivalent point) (ml)×(molecular weight of amino groups)]/[weight (g) of cross-linked silicone particles]}×100

The following method was used for evaluating flowability of the curable epoxy resin composition during molding and characteristics of a cured body obtained from the composition. A cured body was obtained by subjecting the curable epoxy-resin composition to transfer press molding for 2 minutes at a temperature of 175° C. under a pressure of 70 kgf/cm² with subsequent post-curing for 5 hours at 180° C.

### [Flowability in Molding]

Spiral flow was measured at a temperature of 175° C. and under a pressure of 70 kgf/cm² in accordance with the EMMI standard.

### [Properties of a Cured Body]

Flexural modulus of elasticity was measured in accordance with JIS K 6911.

Flexural strength was measured in accordance with JIS K 6911.

### Reference Example 1

A cross-linkable silicone composition was prepared by uniformly mixing the following components: 86.4 parts by weight of a dimethylpolysiloxane represented by the following average formula:

HO—[Si(CH₃)₂O]₁₂—H

which was capped at both molecular terminals with silanol groups and had viscosity of 40 mPa·s (content of silanol groups equals 4.0 wt. %); 9.1 parts by weight of a methylhydrogenpolysiloxane capped at both molecular terminals with trimethylsiloxy groups and having viscosity of 10 mPa·s (content of silicon-bonded hydrogen atoms equal 1.5 wt. %); and 4.5 parts by weight of 3-anilinopropyltrimethoxysilane. A 5-part-by-weight mixture obtained by combining the composition with secondary tridecylether and secondary dodecylether of ethylene oxide (7-mol addition) (43 wt. % of dodecyl groups, 57 wt. % of tridecyl groups, and HLB equal to 12.8), and 97 parts by weight of water were premixed, and then the obtained product was emulsified in a colloid mill and diluted with 100 parts by weight of pure water, whereby an aqueous emulsion of a silicone composition was prepared.

Following this, 1 part by weight of a mixture obtained by combining 1 part by weight of tin (II) octoate and 1 part by weight of a mixture of secondary tridecylether and secondary dodecylether of ethylene oxide (7-mol addition) (43 wt. % of dodecyl groups, 57 wt. % of tridecyl groups, and HLB equal to 12.8) was combined with 10 parts by weight of pure water. The product was emulsified, whereby an aqueous emulsion of tin octoate with average particle size equal to 1.2 μm was prepared. The obtained emulsion was uniformly mixed with the aforementioned aqueous emulsion of the silicone composition and retained in a quiescent state for one day, whereby the silicone composition emulsified in water was cross-linked and produced a uniform aqueous suspension of silicone rubber particles which were free of gel substance. The obtained aqueous suspension was dried in a hot-air-flow dryer resulting in the collection of silicone rubber particles having dimethylsiloxane blocks represented by the following average formula:

—[Si(CH₃)₂O]₁₂—

The average particle size, Type-A-durometer hardness, and content of anilino groups are shown in Table 1.

### Reference Example 2

Silicone rubber particles having dimethylsiloxane blocks represented by the following average formula:

—[Si(CH₃)₂O]₄₀—

were prepared by the same method as in Reference Example 1, except that a dimethylpolysiloxane, represented by the following average formula,

HO—[Si(CH₃)₂O]₄₀—H

which was capped at both molecular terminals with silanol groups and had viscosity of 80 mPa·s (content of silanol groups equals 1.1 wt. %) was used in the same amount as before instead of the dimethylpolysiloxane capped at both molecular terminals with silanol groups and having viscosity of 40 mPa·s and except that 3.2 parts by weight of 3-aminopropyltrimethoxysilane were used instead of 4.5 parts by weight of the aforementioned 3-anilinopropyltrimethoxysilane. The average particle size, Type-A-durometer hardness, and content of amino groups are shown in Table 1.

### Reference Example 3

Silicone rubber particles having dimethylsiloxane blocks, represented by the following average formula,

—[Si(CH₃)₂O]₄₀—

were prepared by the same method as in Reference Example 1, except that 86.4 parts by weight of a dimethylpolysiloxane, represented by the following average formula,

HO—[Si(CH₃)₂O]₄₀—H

which was capped at both molecular terminals with silanol groups and had viscosity of 80 mPa·s (content of silanol groups equals 1.1 wt. %) were used instead of the dimethylpolysiloxane capped at both molecular terminals with silanol groups and having viscosity of 40 mPa·s and except that the aforementioned 3-anilinopropyltrimethoxysilane was not used. The average particle size and Type-A-durometer hardness are shown in Table 1.

### Reference Example 4

Silicone rubber particles having dimethylsiloxane blocks, represented by the following average formula,

—[Si(CH₃)₂O]₄₀—

were prepared by the same method as in Reference Example 1, except that a dimethylpolysiloxane, represented by the following average formula,

HO—[Si(CH₃)₂O]₄₀—H

which was capped at both molecular terminals with silanol groups and had viscosity of 80 mPa·s (content of silanol groups equals 1.1 wt. %) was used in the amount of 86.4 parts by weight instead of the dimethylpolysiloxane capped at both molecular terminals with silanol groups and having viscosity of 40 mPa·s and except that 4.55 parts by weight of 3-glicidoxypropyltrimethoxysilane were used instead of the aforementioned 3-anilinopropyltrimethoxysilane. The average particle size and Type-A-durometer hardness are shown in Table 1.

TABLE 1

| | Ref. Ex. 1 | Ref. Ex. 2 | Ref. Ex. 3 | Ref. Ex. 4 |
|---|---|---|---|---|
| Average particle size | 1.9 | 2.5 | 2.0 | 2.5 |
| (μm) | | | | |
| Type-A-Durometer | 67 | 41 | 57 | 35 |
| hardness | | | | |
| Content of amino groups | 1.56 | 0.29 | 0 | — |
| (wt. %) | | | | |

### Practical Example 1

A curable epoxy-resin composition was prepared by melting and uniformly mixing in a hot two-roll mill the following components: 51 parts by weight of a biphenyl-aralkyl-type epoxy resin (NC 3000, the product of Nippon Kayaku Company, Ltd.; epoxy-resin equivalent=275; softening point=56° C.); 39.0 parts by weight of a biphenyl-aralkyl-type phenol resin (MEH 7851M, the product of Meiwa Kasei Company, Ltd.; phenolic hydroxyl group equivalent=207; softening point is 80° C.); 9 parts by weight of the silicone rubber particles obtained in Reference Example 1; 510 parts by weight of amorphous spherical silica having an average particle size of 14 μm (FB-48X, the product of Denki Kagaku Kogyo Company, Ltd.); 1 part by weight of triphenylphosphine; and 1 part by weight of Carnauba wax. Characteristics of the thus-prepared curable epoxy-resin composition and of a cured body obtained from this composition are shown in Table 2.

### Practical Example 2

A curable epoxy-resin composition was prepared by melting and uniformly mixing in a hot two-roll mill the following components: 51 parts by weight of a biphenyl-aralkyl-type epoxy resin (NC 3000, the product of Nippon Kayaku Company, Ltd.; epoxy-resin equivalent=275; softening point=56° C.); 39.0 parts by weight of a biphenyl-aralkyl-type phenol resin (MEH 7851M, the product of Meiwa Kasei Company, Ltd.; phenolic hydroxyl group equivalent=207; softening point is 80° C.); 18 parts by weight of the silicone rubber particles obtained in Reference Example 1; 510 parts by weight of amorphous spherical silica having an average particle size of 14 μm (FB-48X, the product of Denki Kagaku Kogyo Company, Ltd.); 1 part by weight of triphenylphosphine; and 1 part by weight of Carnauba wax. Characteristics of the thus-prepared curable epoxy-resin composition and of a cured body obtained from this composition are shown in Table 2.

### Comparative Example 1

A curable epoxy-resin composition was prepared by melting and uniformly mixing in a hot two-roll mill the following components: 51 parts by weight of a biphenyl-aralkyl-type epoxy resin (NC 3000, the product of Nippon Kayaku Company, Ltd.; epoxy-resin equivalent=275; softening point=56° C.); 39.0 parts by weight of a biphenyl-aralkyl-type phenol resin (MEH 7851M, the product of Meiwa Kasei Company, Ltd.; phenolic hydroxyl group equivalent=207; softening point is 80° C.); 9 parts by weight of the silicone rubber particles obtained in Reference Example 2; 510 parts by weight of amorphous spherical silica having an average particle size of 14 μm (FB-48X, the product of Denki Kagaku Kogyo Company, Ltd.); 1 part by weight of triphenylphosphine; and 1 part by weight of Carnauba wax. Characteristics of the thus-prepared curable epoxy-resin composition and of a cured body obtained from this composition are shown in Table 2.

### Comparative Example 2

A curable epoxy-resin composition was prepared by melting and uniformly mixing in a hot two-roll mill the following components: 51 parts by weight of a biphenyl-aralkyl-type epoxy resin (NC 3000, the product of Nippon Kayaku Company, Ltd.; epoxy-resin equivalent=275; softening point=56° C.); 39.0 parts by weight of a biphenyl-aralkyl-type phenol resin (MEH 7851 M, the product of Meiwa Kasei Company, Ltd.; phenolic hydroxyl group equivalent=207; softening point is 80° C.); 9 parts by weight of the silicone rubber particles obtained in Reference Example 3; 510 parts by weight of amorphous spherical silica having an average particle size of 14 μm (FB-48X, the product of Denki Kagaku Kogyo Company, Ltd.); 1 part by weight of triphenylphosphine; and 1 part by weight of Carnauba wax. Characteristics of the thus-prepared curable epoxy-resin composition and of a cured body obtained from this composition are shown in Table 2.

### Comparative Example 3

A curable epoxy-resin composition was prepared by melting and uniformly mixing in a hot two-roll mill the following components: 51 parts by weight of a biphenyl-aralkyl-type epoxy resin (NC 3000, the product of Nippon Kayaku Company, Ltd.; epoxy-resin equivalent=275; softening point=56° C.); 39.0 parts by weight of a biphenyl-aralkyl-type phenol resin (MEH 7851M, the product of Meiwa Kasei Company, Ltd.; phenolic hydroxyl group equivalent=207; softening point is 80° C.); 9 parts by weight of the silicone rubber particles obtained in Reference Example 4; 510 parts by weight of amorphous spherical silica having an average particle size of 14 μm (FB-48X, the product of Denki Kagaku Kogyo Company, Ltd.); 1 part by weight of triphenylphosphine; and 1 part by weight of Carnauba wax. Characteristics of the thus-prepared curable epoxy-resin composition and of a cured body obtained from this composition are shown in Table 2.

### Comparative Example 4

A curable epoxy-resin composition was prepared by melting and uniformly mixing in a hot two-roll mill the following components: 51.5 parts by weight of a biphenyl-aralkyl-type epoxy resin (NC 3000, the product of Nippon Kayaku Company, Ltd.; epoxy-resin equivalent=275; softening point=56° C.); 38.5 parts by weight of a biphenyl-aralkyl-type phenol resin (MEH 7851M, the product of Meiwa Kasei Company, Ltd.; phenolic hydroxyl group equivalent=207; softening point is 80° C.); 510 parts by weight of amorphous spherical silica having an average particle size of 14 μm (FB-48X, the product of Denki Kagaku Kogyo Company, Ltd.); 1 part by weight of triphenylphosphine; and 1 part by weight of Carnauba wax. Characteristics of the thus-prepared curable epoxy-resin composition and of a cured body obtained from this composition are shown in Table 2.

TABLE 2

| | Pr. Examples | | Comparative Examples | | | |
|---|---|---|---|---|---|---|
| | 1 | 2 | 1 | 2 | 3 | 4 |
| Spiral flow | 13 | 14 | 7 | 11 | 12 | 13 |
| (in.) | | | | | | |
| Flexural | 1890 | 1730 | 1910 | 1900 | 1870 | 2170 |
| modulus of | | | | | | |
| elasticity | | | | | | |
| (kgf/mm²) | | | | | | |
| Flexural | 15.2 | 12.1 | 14.3 | 14.0 | 14.6 | 17.2 |
| strength | | | | | | |
| (kgf/mm²) | | | | | | |

### INDUSTRIAL APPLICABILITY

Since the curable epoxy resin composition of the present invention possesses improved flowability in molding, and a cured body of the composition has a reduce modulus of elasticity, the composition is suitable for transfer molding, injection molding, potting, casting, powder coating, dip coating, dripping coating, etc., the composition is applicable as sealing agent, paint, coating agent, adhesive agent, or a similar agent for use in electric and electronic devices, especially as sealing and adhesive agents for semiconductor devices.

1. A curable epoxy resin composition comprising the following components (I), (II), and (III):
(I) an epoxy resin;
(II) a curing agent for the epoxy-resin;
(III) cross-linked silicone particles characterized by having secondary amino groups represented by the following general formula:
R¹NH—R²—
where R¹ designates an aryl group or an aralkyl group, and R² designates a bivalent organic group, wherein the secondary amino groups are bonded to silicon atoms that form the cross-linked silicone particles, and wherein the cross-linked silicone particles are used in an amount of 0.1 to 100 parts by weight per 100 parts by weight of the sum of components (I) and (II).

2. The curable epoxy resin composition of claim 1, wherein component (I) is a biphenyl-containing epoxy resin.

3. The curable epoxy resin composition of claim 1, wherein component (II) is a compound that contains phenolic hydroxyl groups.

4. The curable epoxy resin composition of claim 3, wherein the compound of component (II) that contains phenolic hydroxyl groups is a biphenyl-containing phenolic resin.

5. The curable epoxy resin composition of claim 1, wherein component (II) is used in such an amount that the content of epoxy-reactive functional groups contained in component (II) is in the range of 0.5 to 2.5 moles per 1 mole of epoxy groups contained in component (I).

6. The curable epoxy resin composition of claim 1, wherein the group of component (III) designated by R¹ is a phenyl group.

7. The curable epoxy resin composition of claim 1, wherein component (III) has diorganosiloxane blocks represented by the following general formula:
—(R³₂SiO)ₙ
where R³ designates same or different univalent hydrocarbon groups, and “n” is an integer equal to or greater than 3.

8. The curable epoxy resin composition of claim 1, wherein an average size of particles of component (III) ranges from 0.1 to 500 μm.

9. The curable epoxy resin composition of claim 1, wherein the content of secondary amino groups in component (III) ranges from 0.3 to 3.0 wt. %.

10. The curable epoxy resin composition of claim 1, further comprising (IV) an inorganic filler.

11. The curable epoxy resin composition of claim 10, wherein component (IV) is a spherical inorganic filler.

12. The curable epoxy resin composition of claim 11, wherein component (IV) is a spherical amorphous silica.

13. The curable epoxy resin composition of claim 1, further comprising (V) a curing accelerator for the epoxy resin.

14. The curable epoxy resin composition according to claim 1, wherein the curable epoxy resin is a sealing agent or an adhesive agent in a semiconductor.

15. A cured body obtained by curing the curable epoxy resin composition of claim 1.
